(19) United States
(12) Patent Application Publication
(10) Pub. No.: US 2025/0029580 A1
(43) Pub. Date: Jan. 23, 2025

(54) Illuminated Instructional Keyboard Device

(71) Applicant: Kenneth Fazakerley, St. Petersburg, FL (US)

(72) Inventor: Kenneth Fazakerley, St. Petersburg, FL (US)

(21) Appl. No.: 18/353,362

(22) Filed: Jul. 17, 2023

(51) Int. Cl. G10H 1/00; G10H 1/34

(52) U.S. Cl. CPC G10H 1/0016; G10H 1/346; G10H 2220/066; G10H 2220/096; G10H 2240/131

(57) ABSTRACT

The present invention relates to an illuminated instructional keyboard device. The device is primarily comprised of a housing with at least one key with at least one light source and at least one display screen. The device displays the notes of the song while each corresponding key is illuminated such that a user can see what key to press in real-time. A user can also use the mobile device/microphone of the device to identify a song that is playing nearby.

### FIELD OF THE INVENTION

The present invention relates generally to the field of keyboards and digital pianos. More specifically, the present invention relates to an illuminated instructional keyboard device. The device is primarily comprised of a housing with at least one key with at least one light source and at least one display screen. The device displays the notes of the song while each corresponding key is illuminated such that a user can see what key to press in real-time. A user can also use the mobile device/microphone of the device to identify a song that is playing nearby. Accordingly, the present disclosure makes specific reference thereto. Nonetheless, it is to be appreciated that aspects of the present invention are also equally applicable to other like applications, devices, and methods of manufacture.

### BACKGROUND

Many individuals desire to learn to play the piano. However, because playing the piano is so difficult, many beginner musicians may purchase a keyboard or piano that plays or teaches the notes of a plurality of songs. However, said pianos and keyboards are often limited to a fixed number of pre-programmed songs downloaded onto the keyboard or the piano during manufacturing. This is undesirable, as it limits the song selection that a user can learn to play.

Therefore, there exists a long-felt need in the art for an improved keyboard or piano. There also exists a long-felt need in the art for an illuminated instructional keyboard device that teaches a user to play a song. Further, there exists a long-felt need in the art for an illuminated instructional keyboard device that teaches a user to play a song, wherein the song is not limited to a pre-programmed song that was downloaded onto the keyboard during the manufacturing process.

The subject matter disclosed and claimed herein, in one embodiment thereof, comprises an illuminated instructional keyboard device. The device is primarily comprised of a housing with at least one key with at least one light source and at least one display screen. A song can be programmed onto the device via a mobile application and/or via the display screen of the device. Then, the display screen displays the notes of the song while each corresponding key is illuminated. Therefore, the user can see what key to press in real-time. A user can also use the mobile device/microphone of the device to identify a song that is playing nearby and then learn to play the song via the display and keys.

In this manner, the illuminated instructional keyboard device of the present invention accomplishes all of the foregoing objectives and provides an improved keyboard or piano that teaches a user to play a song. Further, the song is not limited to a pre-programmed song that was downloaded onto the keyboard during the manufacturing process.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminated instructional keyboard device. The device is primarily comprised of a housing with at least one key with at least one light source and at least one display screen. In the preferred embodiment, the device can be used as, and resembles a keyboard and/or a digital piano with 88 keys and wherein 52 of the 88 keys are whole note keys and 36 of the keys are sharp/flat keys. The keys may be any color known in the art and are preferably made from a translucent plastic material. Each key is further comprised of at least one light source located within each key. The light source is preferably at least one LED light that can illuminate at least one color. The illumination of the light source can be seen through each key such that each key becomes illuminated.

The housing is also comprised of at least one display screen. The function of the screen is preferably controlled by a knob that allows a user to control a number of settings of the device such as, but not limited to, volume, pitch, song selection, menu settings, power, etc. The housing also has at least one speaker that produces sound as each key is pressed. Further, the speaker may also have at least one microphone that picks up nearby sound to allow the device to identify a song playing near the device.

The device is also comprised of at least one receiver that is preferably in wireless electrical communication with a mobile application via Wi-Fi, Bluetooth, etc. The mobile application allows a user to control various features of the device such as to browse a plurality of songs and/or a song library of the device and/or of the mobile application. The song can then be selected, wherein the corresponding notes and/or sheet music of the song selected can be viewed on the display in real-time as the song plays. In one embodiment, the mobile application (and/or microphone) can be used to identify a song, wherein the song is then sent to the library and can be played on the keys.

While a song is displayed on the display, the notes of the song are preferably displayed on the display in the form of a musical notes on a musical staff. Each note is also simultaneously indicated on the keys via the illumination of the light source of each respective key. In this manner, a user can play/learn the song simply by pressing the illuminated keys as the song plays.

Accordingly, the illuminated instructional keyboard device of the present invention is particularly advantageous as it provides an improved keyboard or piano. To do so, the device teaches a user to play a song, wherein the song is not limited to a pre-programmed song that was downloaded onto the keyboard during the manufacturing process. In this manner, the illuminated instructional keyboard device overcomes the limitations of existing keyboards and pianos known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of an illuminated instructional keyboard device of the present invention in accordance with the disclosed architecture;

FIG. 2 illustrates a rear view of one potential embodiment of an illuminated instructional keyboard device of the present invention in accordance with the disclosed architecture; and

FIG. 3 illustrates a graphical view of one potential embodiment of a mobile application and/or display interface of an illuminated instructional keyboard device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved keyboard or piano. There also exists a long-felt need in the art for an illuminated instructional keyboard device that teaches a user to play a song. Further, there exists a long-felt need in the art for an illuminated instructional keyboard device that teaches a user to play a song, wherein the song is not limited to a pre-programmed song that was downloaded onto the keyboard during the manufacturing process.

The present invention, in one exemplary embodiment, is comprised of an illuminated instructional keyboard device primarily comprised of a housing with at least one key with at least one light source and at least one display screen. In the preferred embodiment, the device can be used as and resembles a keyboard and/or a digital piano with 88 keys and wherein 52 of the 88 keys are whole note keys and 36 of the keys are sharp/flat keys. The keys may be any color known in the art and are preferably made from a translucent plastic material. Each key is further comprised of at least one light source located within each key wherein the light source is preferably at least one LED light that can illuminate at least one color. The illumination of the light source can be seen through each key such that each key becomes illuminated.

The housing is also comprised of at least one display screen. The function of the screen is preferably controlled by a knob that allows a user to control a number of settings of the device such as, but not limited to, volume, pitch, song selection, menu settings, power, etc. The housing also has at least one speaker that produces sounds as each key is pressed. Further, the speaker may also have at least one microphone that picks up nearby sound to allow the device to identify a song playing near the device.

The device is also comprised of at least one receiver that is preferably in wireless electrical communication with a mobile application via Wi-Fi, Bluetooth, etc., that allows a user to control various features of the device such as to browse a plurality of songs and/or a song library of the device and/or of the mobile application. The song can then be selected, wherein the corresponding notes and/or sheet music of the song selected can be viewed on the display in real-time as the song plays. In one embodiment, the mobile application (and/or microphone) can be used to identify a song, wherein the song is then sent to the library and can be played on the keys.

While a song is displayed on the display, the notes of the song are preferably displayed on the display in the form of a musical notes on a musical staff. Each note is also simultaneously indicated on the keys via the illumination of the light source of each respective key. In this manner, a user can play/learn the song simply by pressing the illuminated keys as the song plays.

Accordingly, the illuminated instructional keyboard device of the present invention is particularly advantageous as it provides an improved keyboard or piano. To do so, the device teaches a user to play a song, wherein the song is not limited to a pre-programmed song that was downloaded onto the keyboard during the manufacturing process. In this manner, the illuminated instructional keyboard device overcomes the limitations of existing keyboards and pianos known in the art.

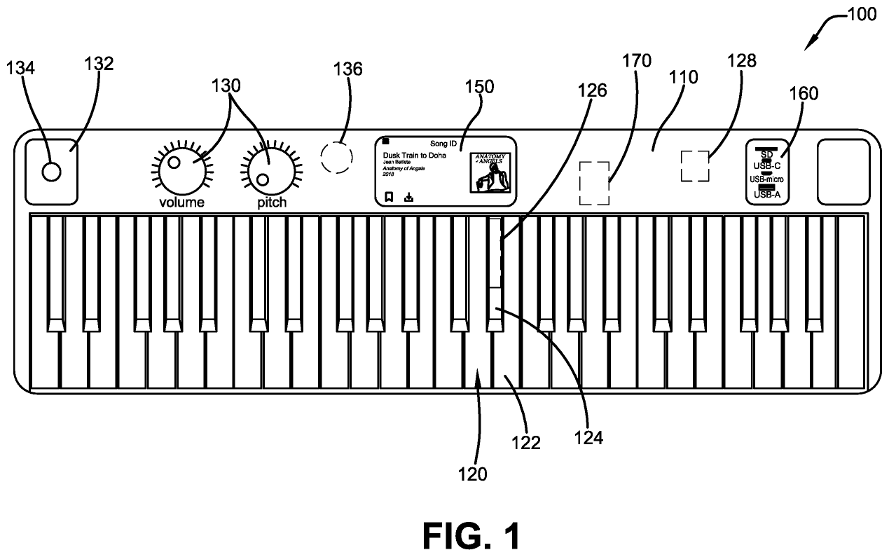

Referring initially to the drawings, FIG. 1 illustrates a top view of one potential embodiment of an illuminated instructional keyboard device of the present invention in accordance with the disclosed architecture. The device 100 is primarily comprised of a housing 110 with at least one key 120 with at least one light source 126 and at least one display screen 150. In the preferred embodiment, the device 100 can be used as and resembles a keyboard and/or a digital piano. The housing 110 of the device 100 may resemble any piano or keyboard size, shape, and/or style and may be made from a natural material such as wood or a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The housing 110 is comprised of at least one key 120. In the preferred embodiment, the device 100 has 88 keys 120, wherein 52 of the 88 keys 120 are whole note keys 122 and 36 of the 88 keys 120 are sharp/flat keys 124. The keys 122, 124 may be any color known in the art. It is preferred that both sets of keys 122,124 differ in color. It should be appreciated however that the device 100 may be scaled down in size and may have any number of keys 120 so long as the device 100 has at least one whole note key 122 and at least one sharp/flat key 124.

In the preferred embodiment, both sets of keys 122,124 are made from a translucent plastic material. The keys 122,124 may be weighted (i.e., a weighted action) or non-weighted keys. The keys 122,124 may also be made from an ivory or other synthetic, translucent material. Each key 122,124 is further comprised of at least one light source 126 located within each key 122, 124. In the preferred embodiment, the light source 126 is at least one LED light that can illuminate at least one color. The illumination of the light source 126 can be seen through each key 122,124 such that each key 122,124 becomes illuminated, as will be explained more fully below.

The housing 110 is comprised of at least one control knob 130. The knob 130 may allow the user to control a number of settings of the device 100 such as, but not limited to, volume, pitch, song selection, menu settings, power, etc. In one embodiment, the knob 130 may be in the form of a button, a switch, etc. The housing also has at least one speaker 132 that produces sounds as each key 122,124 is pressed. The speaker 132 may also have at least one microphone 134 that picks up nearby sound to allow the device 100 to identify a song playing near the device 100.

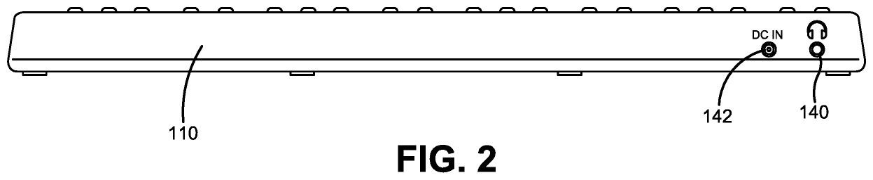

FIG. 2 illustrates a rear view of one potential embodiment of an illuminated instructional keyboard device 100 of the present invention in accordance with the disclosed architecture. The housing 110 also has at least one headphone jack 140 and at least one power jack 142. The headphone jack 140 may be any headphone jack style known in the art such as, but not limited to, USB C, lightning. 3.5 MM, 2.5 mm, ¼ in., etc. The power jack 142 may be any female power jack size known in the art such as, but not limited to, 9V, 12V, etc. The housing 110 may also have at least one connection port 160 that allows a user to transfer data to/from a processor 128 of the device 100. The port 160 may be, but is not limited to, any USB port style known in the art, SD card, etc.

The housing 110 is also comprised of at least one display screen 150. In the preferred embodiment, the screen 150 is a touchscreen. However, in differing embodiments the screen 150 may be any screen type such as, but not limited to, an LCD screen, an OLED screen, an ELD screen, an LED-backlit LCD screen, an LED screen, a PDP screen, etc., wherein the functions of the screen 150 can be controlled by the knob 130.

The device 100 is further powered by at least one battery 128. The battery 128 may be a disposable battery 128 or a rechargeable battery 128 in the form of an alkaline, nickel-cadmium, nickel-metal hydride battery 128, etc. such as any 3V-12 volts DC battery 128 or other conventional battery 128 such as A, AA, AAA, etc., that supplies power to the device 100. Throughout this specification the terms “battery” and “batteries” may be used interchangeably to refer to one or more wet or dry cells or batteries 128 of cells in which chemical energy is converted into electricity and used as a source of DC power. References to recharging or replacing batteries 128 may refer to recharging or replacing individual cells, individual batteries 128 of cells, or a package of multiple battery cells as is appropriate for any given battery 128 technology that may be used.

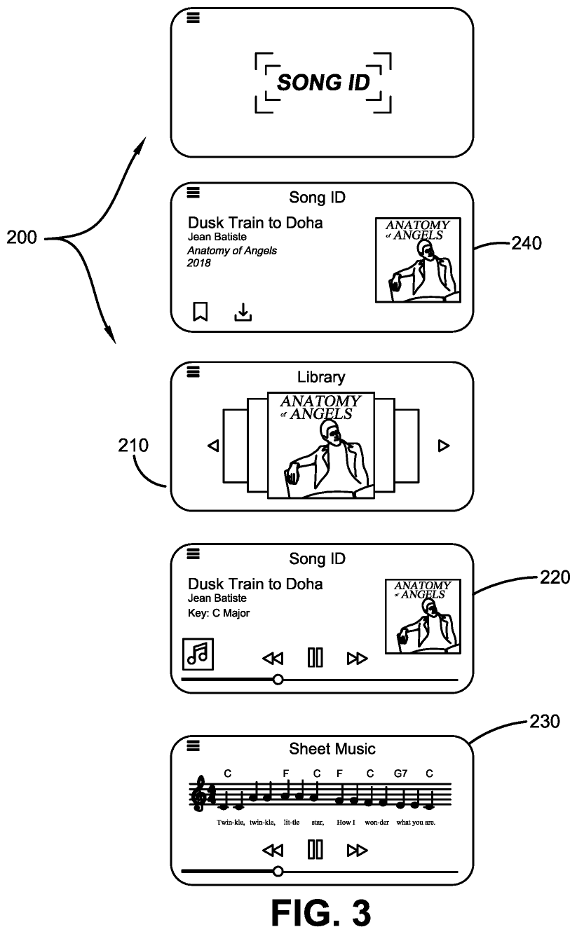

FIG. 3 illustrates a graphical view of one potential embodiment of a mobile application 200 and/or display 150 interfaces of an illuminated instructional keyboard device of the present invention in accordance with the disclosed architecture. The device 100 is also comprised of at least one receiver 136 within the processor 170. The receiver 136 is preferably in wireless electrical communication with a mobile application 200 via Wi-Fi, Bluetooth, etc. The mobile application 200 allows a user to control various features of the device 100. The application 200 may allow a user to browse a plurality of songs and/or a song library 210 of the device 100 and/or of the mobile application 200. The song can then be selected 220, wherein the corresponding notes and/or sheet music 230 of the song selected can be viewed on the display 150 in real-time as the song plays. In one embodiment, the mobile application 200 (and/or microphone 134) can be used to identify a song, wherein the song is then sent to the library 210 and can be played on the keys 120.

While a song is displayed on the display 150, a user may speed up/slow down the song, rewind the song, etc. The notes of the song may be displayed on the display 150 in the form of musical notes on a musical staff. Each note is also simultaneously indicated on the keys 120 via the illumination of the light source 126 of each respective key 122,124. In this manner, a user can play/learn the song simply by pressing the illuminated keys 122,124 as the song plays. In one embodiment, the song does not continue playing until each illuminated key 122,124 is pressed.

It should be noted that all features of the mobile application 200 may be accessible and configurable on the display 150 (as seen in FIG. 3) without the need for the mobile application 200. Further, the processor 170 may have a song library that is linked or independent from the song library 210 of the mobile application.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “illuminated instructional keyboard device” and “device” are interchangeable and refer to the illuminated instructional keyboard device 100 of the present invention.

Notwithstanding the foregoing, the illuminated instructional keyboard device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the illuminated instructional keyboard device 100 as shown in the FIGS. are for illustrative purposes only, and that many other sizes and shapes of the illuminated instructional keyboard device 100 are well within the scope of the present disclosure. Although the dimensions of the illuminated instructional keyboard device 100 are important design parameters for user convenience, the illuminated instructional keyboard device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illuminated instructional keyboard device comprising:
a housing;
a whole note key;
a light source;
a processor;
a battery;
a speaker;
a microphone; and
a display screen.

2. The illuminated instructional keyboard device of claim 1, wherein the light source is positioned within the whole note key.

3. The illuminated instructional keyboard device of claim 2, wherein the light source is an LED light.

4. The illuminated instructional keyboard device of claim 3, wherein the light source illuminates in correspondence with a musical note of a song selected and displayed on the display screen.

5. An illuminated instructional keyboard device comprising:
a housing;
a whole note key;
a first light source positioned within the whole note key;
a sharp note key;
a second light source positioned within the sharp note key;
a flat note key;
a third light source positioned within the flat note key;
a processor;
a battery;
a speaker;
a microphone; and
a display screen.

6. The illuminated instructional keyboard device of claim 5, wherein the whole note is comprised of a first color that differs from a second color of the sharp key and of the flat key.

7. The illuminated instructional keyboard device of claim 5, wherein the microphone can identify a song.

8. The illuminated instructional keyboard device of claim 7, wherein a note of the song can be displayed on the display screen.

9. An illuminated instructional keyboard device comprising:
a housing;
a whole note key;
a first light source positioned within the whole note key;
a sharp note key;
a second light source positioned within the sharp note key;
a flat note key;
a third light source positioned within the flat note key;
a processor;
a battery;
a speaker;
a microphone;
a display screen; and
a mobile application.

10. The illuminated instructional keyboard device of claim 9, wherein each of the whole note key, the sharp note key and the flat note key is comprised of a weighted action key.

11. The illuminated instructional keyboard device of claim 9, wherein each of the whole note key, the sharp note key and the flat note key is comprised of a translucent plastic material.

12. The illuminated instructional keyboard device of claim 9 further comprising a headphone jack.

13. The illuminated instructional keyboard device of claim 9 further comprising a connection port.

14. The illuminated instructional keyboard device of claim 13, wherein the connection port is comprised of a USB port or an SD port.

15. The illuminated instructional keyboard device of claim 9, wherein the display screen is a touchscreen.

16. The illuminated instructional keyboard device of claim 9, wherein the mobile application is in wireless electrical communication with a receiver of the processor.

17. The illuminated instructional keyboard device of claim 16, wherein the mobile application is comprised of a song library that allows a user to select a song.

18. The illuminated instructional keyboard device of claim 17, wherein the display screen displays the song in the form of a music note on a music staff.

19. The illuminated instructional keyboard device of claim 18, wherein the light source of the whole note key, the sharp note key or the flat note key corresponds to the music note that is illuminated via the processer as the song plays.

20. The illuminated instructional keyboard device of claim 9, wherein the mobile application can identify a song.
